(19) United States
(12) Patent Application Publication
(10) Pub. No.: US 2009/0288913 A1
(43) Pub. Date: Nov. 26, 2009

(54) CLIMB-ASSIST DEVICE

(75) Inventor: Bent L. Nielsen, Huntington, WV (US)

Correspondence Address: SUGHRUE MION, PLLC, 2100 PENNSYLVANIA AVENUE, N.W., SUITE 800, WASHINGTON, DC, 20037, US

(73) Assignee: TOWER LOGISTICS, LLC, Huntington, WV (US)

(21) Appl. No.: 12/295,808

(22) PCT Filed: Apr. 4, 2006
(86) PCT No.: PCT/US06/12589

§ 371 Date: Oct. 2, 2008

(51) Int. Cl. A62B 35/00

(52) U.S. Cl. 182/8; 182/3

(57) ABSTRACT

A climbing assistance device having a connection assembly disposed at a predetermined location on the structure, a yoke attachable to a person, a counterweight connected to the yoke by a cable which passes through a pulley system, and a stabilizer operative to stabilize the counterweight to prevent rotation thereof. By employing the stabilizer, the counterweight remains stable during ascent and descent, and the load of the counterweight is controlled.

### BACKGROUND OF THE INVENTION

The present invention generally relates to an apparatus for assisting a user in climbing a tall structure or tower.

Related climbing assistance devices contain a pulley system, a yoke attachable to a harness of a climber, and a counterweight. The counterweight is used to counterbalance a user's weight when climbing a ladder in a tall structure such as a windmill or a wind turbine. Due to the provision of a counterweight, a user is required to exert less energy during a long climb.

The yokes of related climbing assistance devices are typically attached to the user's shoulders, and the counterweight is attached to the pulley system using a single guide cable. The counterweight and guide cable are positioned either behind the user or to a side of the user, such that the user is positioned substantially between the ladder and the counterweight. In the related systems, the counterweight is required to extend beyond a centerline of the ladder, and at times, to be angled from the ladder or positioned to a side of the ladder. This type of positioning will exert a substantial amount of undesirable lateral loads to the top of the tower or climbing structure and may cause a break in the ladder if tension is applied.

Further, since the counterweight is attached via a single guide cable, the movement of the counterweight, during ascent and descent, will cause the counterweight to create a frequency/counter frequency such that the counterweight will twist. Such occurrence causes unsafe conditions for the user and can result in disruption of the weight distribution of the user. As climbing structures become taller and taller, the risk of counterweight twisting increases since towers are extremely vulnerable to harmonic failure.

In related climbing assistance devices, there is no means to return the yoke to an upper or lower position. Thus, if one person ascends or descends a tower, the yoke must stay in that position until someone physically moves the yoke to another level or platform. The inability to move the yoke, unless physically moved by a user, restricts the use of the related systems to just a single person.

### SUMMARY OF THE INVENTION

In view of the foregoing, aspects of the present invention are provided to address at least the above problems. Thus, an exemplary feature of the present invention is to provide a climbing assistance device that results in enhanced control of a counterweight to increase safety of a user. In an illustrative, non-limiting embodiment, a climbing assistance device is provided. The climbing assistance device has a connection assembly disposed at a predetermined location on the structure, a yoke attachable to a person, a counterweight connected to the yoke by a cable which passes through a pulley system, and a stabilizer operative to stabilize the counterweight to prevent rotation thereof.

By employing the device of the present invention, a counterweight remains stable during ascent and descent, and the load of the counterweight is controlled. Such features increase the safety of a user.

### BRIEF DESCRIPTION OF THE DRAWINGS

Aspects of illustrative, non-limiting embodiments of the present invention will become more apparent by describing in detail embodiments thereof with reference to the attached drawings in which:

FIG. 1 shows a yoke and counterweight of a ladder assembly;

FIG. 2 shows a tensioner for the counterweight cables and a return assembly for the yoke;

FIG. 3 shows a counterweight passage for a platform of a ladder assembly; and

FIG. 4 shows a connection assembly for the yoke and counterweight at a top of the ladder assembly.

### DETAILED DESCRIPTION OF THE INVENTION

The following description of illustrative, non-limiting embodiments of the invention discloses specific configurations and components. However, the embodiments are merely examples of the present invention, and thus, the specific features described below are merely used to more easily describe such embodiments and to provide an overall understanding of the present invention. Accordingly, one skilled in the art will readily recognize that the present invention is not limited to the specific embodiments described below. Furthermore, the descriptions of various configurations and components of the present invention that are known to one skilled in the art are omitted for the sake of clarity and brevity.

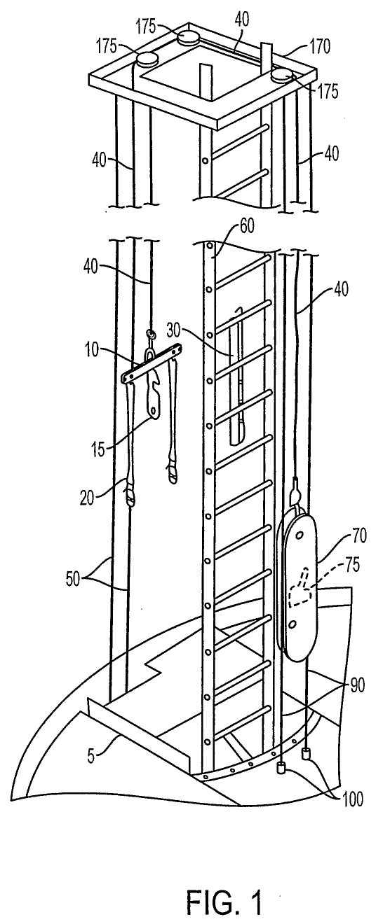

FIG. 1 shows a climbing assistance device according to an illustrative non-limiting embodiment of the present invention. The view is provided from a platform 5 of a tower or structure to which the ladder 60 is attached. As shown, a connection assembly 170 is disposed at a predetermined location on the structure. The connection assembly 170 includes a pulley system 175. The pulley system 175 of FIG. 1 is provided merely for illustrative purposes. Any suitable type of pulley system can be used. The climbing assistance device is further provided with a yoke assembly 10, a counterweight 70 and a stabilizer (shown as guide cables 90). The yoke assembly 10 is connected to the counterweight 70 via a center cable 40 that passes through the pulley system 175 of the connection assembly 170. The stabilizer (shown as guide cables 90), acts to stabilize the counterweight 70 to reduce or prevent twisting of the counterweight 70. When the yoke assembly 10 is attached to a user, the amount of energy exerted by the user is reduced due to the counterbalance action of the counterweight 70.

The yoke assembly 10 can be any type of yoke suitable for climbing, and is shown in FIG. 1 to include a safety cable 15 that can be attached to either the tower or structure to be climbed or to the ladder 60 itself. Yoke fasteners 20 are provided to attach to a suitable harness or device worn by the user, such that the yoke fasteners 20 attach to a user's hip area and can be implemented in a type of body harness. By attaching the yoke fasteners 20 to a user's hip area, the user is provided with better balance and is able to keep their head region away from the ladder 60, such that the user can lean backwards during climbing. The yoke fasteners 20 can be any conventional type of clamp or fastener and are not limited to the fasteners as shown. Further, the yoke fasteners 20 are not limited to be attached to a user's hip area. For example, they can also be attached to the chest area or shoulder area.

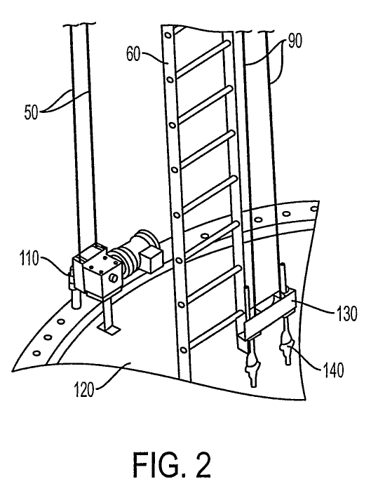

FIG. 1 also shows return cables 50 that enable the yoke assembly 10, when empty, to ascend and descend along the length of the ladder 60 via a yoke return assembly 110 (shown in FIG. 2). Further, a yoke parking device 30 is provided on the ladder 60 to restrict movement of the yoke assembly 10 if so required. The yoke parking device 30 can be any type of conventional hook or fastening device and the position of the yoke parking device 30 is not limited to the ladder 60. For example, the yoke parking device 30 could alternatively be positioned on the actual tower to which the ladder 60 is attached.

The counterweight 70 is provided on a side of the ladder 60 which opposes the yoke assembly 10. The counterweight 70 is used to counterbalance a user's weight to reduce the amount of energy exerted during climbing of the ladder 60. Service or repair work on tall structures, such as a windmill or a wind turbine, require a user to repeatedly climb up and down a series of ladders. The reduction of user fatigue and increased safety are of great concern. As stated above, the counterweight 70 is provided on an opposite side of the ladder 60 as the yoke assembly 10 (i.e., the counterweight 70 is provided on the backside of the ladder 60). Thus, the yoke assembly 10 will not become entangled with the counterweight 70. Further, there are no other structures provided behind the ladder to interfere with the counterweight 70 and its respective cables, etc. Due to the positioning of the counterweight 70 and the yoke assembly 10, the load between the user and the counterweight 70 is centralized in a more balanced manner and is controlled around the ladder 60.

The stabilizer of FIG. 1 is formed of at least two guide cables 90 to help guide the counterweight 70 up and down the length of the ladder 60. One guide cable 90 is provided on each side of the counterweight, thus forming a pair of guide cables 90 along which the counterweight is slidable, as shown in FIG. 1. At an uppermost end, the guide cables 90 can be attached to the connection assembly 170. At a lowermost end, the guide cables can be connected to ground or a tensioner device 130 (discussed in further detail below). Due to the provision of the two guide cables 90, the counterweight 70 remains substantially centered and stable during movement, and twisting of the counterweight 70 is avoided. Although FIG. 1 depicts the stabilizer as two guide cables 90, any other type of device for stabilizing movement of the counterweight 70 can be provided (e.g., a track attached to the ladder 60). FIG. 1 also shows cable fasteners 100 that secure the guide cables 90 to the platform 5. Any type of suitable fastener can be used.

The counterweight 70 is provided with a base weight and can have additional weight adjustments to allow a user to set the counter balance to a preferred setting. The yoke assembly 10 can also be provided with a removable weight to counter the counterweight 70 for users of a less than average weight class.

As set forth above, the counterweight 70 is connected to the yoke assembly 10 via the center cable 40. Therefore, as a user ascends up the ladder 60, the length of the center cable 40 on the user side decreases, while the length of the center cable 40 on the counterweight 70 side increases. Thus, the load on the counterweight 70 side of the ladder 60 in turn increases. As structures or towers reach heights of greater than 55 meters, a user, especially a user of a less than average weight class, must expend great force to begin descent. Accordingly, a weight stabilizer can be provided to ensure that the starting weight for the ascent and descent on the ladder 60 will be approximately the same. The weight stabilizer can include an elastic membrane that is attached to the connection assembly 170 at one end and to the counterweight 70 at an opposite end, such that the elastic membrane follows along the center cable 40 between the connection assembly 170 and the counterweight 70. The elastic membrane elongates and stretches as the counterweight 70 descends down the ladder. Due to the elasticity provided therein, the elastic membrane will help carry a portion of the load provided by the counterweight 70 and the center cable 40, such that the weight becomes stabilized. This in turn will enable a user to easily descend back down the ladder 60 even when the tower or structure is greater than 55 meters in height.

The counterweight 70 can be provided with a dynamic brake system 75 that prevents a runaway condition during descent of the counterweight 70. The brake system 75 is provided inside the counterweight 70, as shown by the dashed lines in FIG. 1. If the counterweight 70 moves too quickly along the guide cables 90, the brake 75 will initiate and stop movement of the counterweight 70. The dynamic brake system 75 provides fall protection and also can prevent an overly rapid ascent up the ladder 60. Such brake systems are commonly known in the art as runaway safe lock systems. Since such systems are commonly known in the art, specific details are not provided herein.

As shown in FIG. 1, the climbing assistance device of the present invention does not require the use of angled cables. The guide cables 90 are retained at least substantially parallel to the ladder 60 and structure to be climbed, such that the guide cables 90 are arranged in a substantially vertical manner. Therefore, any loads induced on the structure are vertical, not lateral. The reduction of lateral loads in turn reduces harmonic load failure of the system.

A sensor system can also be provided for the purpose of recording and transmitting the movement of the yoke assembly 10. A remote station or facility (not shown), can use this information for various purposes including recording personnel movement for maintenance verification and monitoring for safe movement including emergency indication of a fall.

The information provided by the sensor system can further include a duration of which the yoke assembly 10 is in use. The duration includes the time the yoke assembly 10 leaves a docking position at a top or bottom of the ladder 60 to a time the yoke assembly 10 returns to the docking position at the top or bottom of the ladder 60. A velocity of the user can be monitored, as well as how long the motor of the yoke return assembly 110 is in use (i.e., to move either an empty yoke assembly 10 or a yoke assembly 10 containing equipment). Further, the sensor system may be provided with the ability to control, by authentication, which user is permitted to use the climbing assistance device. Authentication methods may include, but are not limited to, RFID passive or active tags, use of a PIN number, fingerprint identification, retinal scan, voice recognition, etc.

The sensor system can be formed of standard sensors known in the art for recording and transmitting positional information and data. Such sensors can be positioned at intervals along the length of the ladder 60. Further, a microchip or other conventional device for recording and transmitting data is provided, for example, at the base of the tower or structure. The microchip is configured to communicate with the sensors. Data provided by the sensors and/or microchip will be transmitted wirelessly to either a remote portable device or a facility. Conventional communication systems can be used to record and transfer the data (i.e., Bluetooth technology and SCADA systems). Non-limiting examples of sensors include: an altimeter—used to measure altitude, an accelerometer—used to measure acceleration (taking the integral of this value will give velocity, and the integral of velocity will give position), and a rotary counter placed on a sheave or pulley to measure rotations and the sheave or pulley circumference can be used to give distance. Non-limiting examples of microchips can include a PIC Microcontroller, an Atmel AVR, a BASIC Stamp, a Gumstix Waysmall, etc.

FIG. 2 shows an illustrative non-limiting embodiment in regard to features provided at ground level 120 of the climbing assistance device. For example, a motorized yoke return assembly 110 is provided. The motorized yoke return assembly 110 is used to return the yoke assembly 10, via the return cables 50, to the top or bottom of the ladder 60 after a user has detached from the yoke assembly 10, or to lift tools and parts up and down the ladder 60. The motorized yoke return assembly 110 allows positioning of the yoke assembly 10 via a remote control station. Since the yoke assembly 10 can be moved without the assistance of the user, multiple users can use the system for ascent and descent regarding of their intended elevation. For example, once a user reaches a desired platform, the yoke assembly 10 can be sent up or down the length of the ladder 60 to retrieve another user and/or tools.

Further, a tensioner device 130 is provided. The tensioner device 130 is connected to the ground 120 at one end and connected to the guide cables 90 of the counterweight 70 at the other end. The tensioner device 130 provides tension balance to the system, and ensures adequate spacing of the guide cables 90. Such provisions reduce fatigue on the guide cables 90.

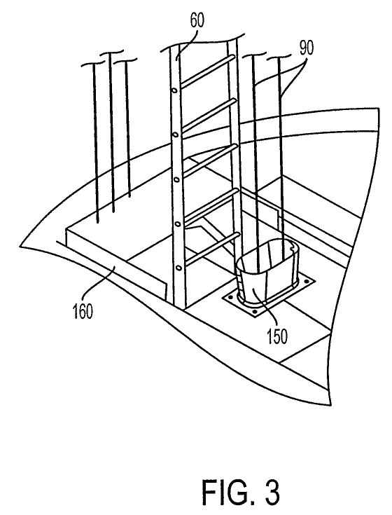

FIG. 3 shows an illustrative, non-limiting embodiment of another platform 160 provided along the tower or structure to which the ladder 60 is attached. As shown, the platform 160 can be provided with a counterweight passage 150. Due to the counterweight passage 150 and the guide cables 90, which keep the counterweight 70 stable and centered, the counterweight 70 passes through the platform 160 easily and without disruption. The counterweight passage 150 is a hollow tubular member that protrudes from the platform 160. The counterweight passage 150 tapers from a top periphery portion to a base thereof, such that the base is smaller than the top portion. The tapered shape of the counterweight passage 150 helps guide the counterweight 70 through the platform 160 during descent in the event that the counterweight 70 and guide cables 90 become slightly offset from a center position. As shown in FIG. 3, the counterweight passage 150 has an elliptical shape in cross-section. However, any suitable shape can be used so long at the passage tapers from a top portion to a base thereof. The counterweight passage 150 can be provided in each platform of the structure being climbed.

In an alternate embodiment, the counterweight passage 150 is equipped with lighting for use in emergency situations, such as a power outage. When illuminated, the lights of the counterweight passage 150 will act as emergency lights to guide a user safely up or down the ladder 60 or to a nearest platform. Any type of conventional emergency illuminating device can be used so long as the device does not obstruct the ability of the counterweight 70 to pass through the counterweight passage 150.

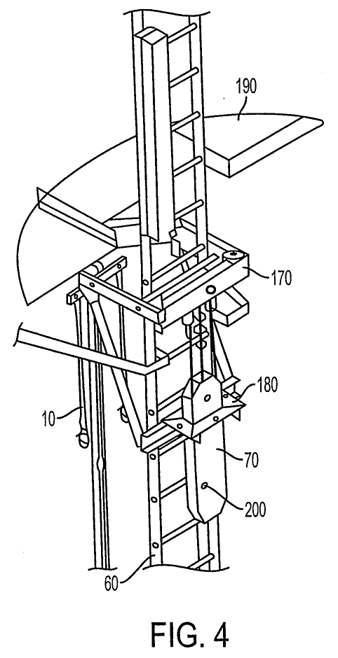

FIG. 4 shows an illustrative, non-limiting embodiment of a top platform 190 of a tower or structure to which the ladder 60 is attached. As shown, the yoke assembly 10 and the counterweight 70 are rotated up and down the ladder 60 via the connection assembly 170. The connection assembly 170 of FIG. 4 is shown as a C-frame system, however, the connection can be provided by any other conventional assembly that includes a pulley system. The connection assembly 170 centralizes the load around the ladder 60.

FIG. 4 also depicts a counterweight parking device 180 located at a top portion of the ladder 60, for stably holding the counterweight 70 when not in use. The counterweight parking device 180 is shown as a rectangular member with an opening in the center for pass-through of the counterweight 70. The inner periphery of the center opening can be provided with rubber or other suitable materials to help retain the counterweight 70. The counterweight parking device 180 is not limited to the structure as shown in FIG. 4, and may be any suitable device capable of at least partially holding the counterweight 70. For example, the counterweight parking device 180 can be any suitable shape having a rubber portion that substantially conforms to the shape of the counterweight 70.

Additional devices, similar to the counterweight parking device 180, can be provided at various locations along the ladder 60 to act as guide devices, and to maintain control of the guide cables 90 and the counterweight 70. Such guide devices are similar to the counterweight parking device 180, except that a thickness of the rubber portion along the inner periphery of the center opening is reduced so as not to hinder movement of the counterweight 70 therethrough. Since the guide devices are similar in appearance to the counterweight parking device 180, the guide devices are not reproduced in the figures.

In the non-limiting embodiments described above, certain features such as the counterweight 70, the counterweight parking device 180 and the counterweight passage 150, can be formed of molded reinforced plastic and composite materials that are commonly known in the art, and the counterweight 70 can be molded so as to be hollow. By forming such parts with reinforced molded plastic and composite material parts, rather than with metal, the cost of manufacturing, inventory, assembly, shipping & handling, installation and service can be reduced.

The previous description of the non-limiting embodiments is provided to enable one skilled in the art to make and use the present invention. Moreover, various modifications to these embodiments will be readily apparent to those skilled in the art, and the generic principles and specific examples defined herein may be applied to other embodiments without the use of inventive faculty. For example, although the climbing assistance aid is discussed in regard to a windmill or wind turbine, the features of the present invention can be applied to any type of structure that requires a user to ascend or descent great heights, such as cell towers, radio towers, elevator shafts, vertical mine shafts, tower cranes and ski lifts. Therefore, the present invention is not intended to be limited to the embodiments described herein, but is to be accorded the widest possible scope as defined by the recitations of the claims and equivalents thereof.

What is claimed is:

1. A climbing assistance device for climbing a tall structure, comprising:
a connection assembly disposed at a predetermined location on the structure and including a pulley system;
a yoke attachable to a person;
a counterweight connected to the yoke by a center cable which passes through the pulley system; and
a stabilizer operative to stabilize the counterweight to prevent rotation thereof.

2. The climbing assistance device according to claim 1, wherein the stabilizer comprises at least two guide cables along which the counterweight is slidable.

3. The climbing assistance device according to claim 1, wherein at least a portion of the connection assembly is attached to a top portion of a ladder.

4. The climbing assistance device according to claim 3, further comprising a motorized yoke return assembly operative to transport the yoke up and down the ladder.

5. The climbing assistance device according to claim 3, wherein the ladder is positioned between the yoke and the counterweight, such that the counterweight is centered along a back side of the ladder and the yoke is centered along a front side of the ladder.

6. The climbing assistance device according to claim 3, wherein the yoke is attachable to a user.

7. The climbing assistance device according to claim 6, wherein the yoke comprises yoke fasteners that attach to the user and a safety cable.

8. The climbing assistance device according to claim 7, wherein the yoke fasteners attach to a hip area of the user.

9. The climbing assistance device according to claim 6, wherein the yoke is provided with at least one removable weight.

10. The climbing assistance device according to claim 6, further comprising a yoke parking device operative to lock the yoke in a set position.

11. The climbing assistance device according to claim 10, wherein the yoke parking device is provided on the ladder.

12. The climbing assistance device according to claim 1, wherein the counterweight is formed of molded plastic.

13. The climbing assistance device according to claim 2, further comprising a tensioner device, wherein at least a portion of each of the at least two guide cables is attached to the tensioner device.

14. The climbing assistance device according to claim 1, wherein a total weight of the counterweight is adjustable.

15. The climbing assistance device according to claim 3, wherein the ladder is attached to a structure having at least one platform, and a tapered passage is provided in the platform to allow the at least two guide cables and the counterweight to pass there through.

16. The climbing assistance device according to claim 1, further comprising a counterweight parking device that retains the counterweight in a stationary position.

17. The climbing assistance device according to claim 1, further comprising an elastic membrane having one end attached to the connection assembly and an opposite end attached to the counterweight.

18. The climbing assistance device according to claim 2, wherein the counterweight is provided with a brake.

19. The climbing assistance device according to claim 18, wherein the brake is positioned in the counterweight, such that the counterweight can stop at any point along the at least two guide cables.

20. The climbing assistance device according to claim 2, wherein the at least two guide cables are positioned in a substantially vertical direction with respect to a ground level.

21. The climbing assistance device according to claim 3, further comprising a sensor assembly to detect movement of the yoke, the sensor assembly having a plurality of sensors mounted at various positions along a length of the ladder and a microchip that communicates with the plurality of sensors.

22. The climbing assistance device according to claim 15, wherein the tapered passage is formed of molded plastic and is a hollow tubular member that protrudes from the platform and tapers from a top periphery portion to a base portion.

23. The climbing assistance device according to claim 15, wherein the tapered passage is provided with an illuminating device.

24. The climbing assistance device according to claim 16, wherein the counterweight parking device is formed of molded plastic, and an inner periphery of the counterweight parking device is lined with rubber to retain the counterweight.
